(19) United States
(12) Patent Application Publication
(10) Pub. No.: US 2002/0054435 A1
(43) Pub. Date: May 9, 2002

(54) Arrangement and device for transforming optical rays

(76) Inventor: Vladimir Davydenko, Dortmund (DE)

Correspondence Address: HOFFMAN WASSON & GITLER, 2361 JEFFERSON DAVIS HIGHWAY, SUITE 522, ARLINGTON, VA, 22202

(21) Appl. No.: 09/985,625

(22) Filed: Nov. 5, 2001

(30) Foreign Application Priority Data
Nov. 6, 2000 (DE) 100 54 950.0

(51) Int. Cl. G02B 27/10

(52) U.S. Cl. 359/626; 359/618

(57) ABSTRACT

A device for imaging of modulated light onto a thermally sensitive medium having lens means which can image the beam cross-section of the light beam which emerges from a modulator plane onto the surface of the thermally sensitive medium. The lens means is made such that the cross-section of the light beam emerging from the modulator plane can be imaged in the first direction (x) more dramatically enlarged, or more weakly reduced, onto the surface than in the second direction (y), and at least for the duration of irradiation of the surface of the thermally sensitive medium with the light beam imaged by the lens means, the surface can be moved in the second direction (y).

### BACKGROUND OF THE INVENTION

This invention relates to a device for imaging of modulated light onto a thermally sensitive medium. The device has a lens means which can image the beam cross-section of the light beam which emerges from a modulator plane onto the surface of a thermally sensitive medium.

Devices of the aforementioned type have long been known and are used to image light which has been modulated. One example used is with print information onto the thermally sensitive surface of a print roller, or the like. Generally, the beam cross-section of the light beam, imaged onto the surface of the thermally sensitive medium, will be square so that pixels with a square outline are formed Alternatively, there are also imaging devices which produce a circular outline of the pixel. Providing symmetrical, specifically square, or circular, outlines of a pixel is almost essential for preparing an image with high definition.

But, on the other hand, new thermally sensitive media, especially so-called process-less media, have recently been in use for printing devices and the like; they allow very high definition, but on the other hand, have relative low sensitivity for the thermal conversion process to be achieved.

The object of this invention is to devise a device, of the initially mentioned type, in which a higher power per surface can be transmitted while preserving symmetrical pixels, so that thermally sensitive media with lower sensitivity can also be used.

### SUMMARY OF THE INVENTION

Desired improvements are achieved in the invention in that the lens means are made such that the cross-section of the light beam emerging from the modulator plane can be imaged in the first direction more dramatically enlarged or more weakly reduced into the surface, than in the second direction, and furthermore at least for the duration of irradiation of the surface of the thermally sensitive medium with the light beam imaged by the lens means, the surface can be moved in the second direction. In doing so, the first direction and the second direction can be essentially perpendicular to one another and to the propagation direction of the light beam. It is also possible for the surface to be moved only in the second direction for the duration of irradiation. Alternatively, the surface can be moved in the direction in which the motion has a component in the second direction. The device can be made such that the beam cross-section of the light beam emerging from the modulator plane is essentially square and that the cross-section of the light beam striking the surface is rectangular due to the different enlargement in the first direction and the second direction. In addition, the speed of motion of the surface in the second direction can be chosen such that the surface cutout irradiated during the interval of irradiation by the light beam with a rectangular cross-section is square. This results in that overall a square surface cutout which corresponds to one pixel is scanned by the light beam, but this light beam has a rectangular and essentially smaller surface than the ultimately entire scanned surface cutout. Therefore, at the time of the respective irradiation, more power per surface is transmitted to the thermally sensitive medium than for a light beam with a square cross-section. Therefore, thermally sensitive media with lower sensitivity can be used, because the power transmitted at each instant per surface can be significantly increased.

According to preferred embodiments of this invention, movement of the surface in the second direction can be achieved by the surface being located on a roller-shaped carrier device, and the surface can be moved in the second direction by turning the carrier device around its roller axis. Alternatively, movement of the surface in the second direction can be achieved by linear motion of a carrier device which bears the surface.

According to one preferred embodiment of this invention, the lens means has cylindrical lens elements. Here, the cylinder axes of the cylindrical lens elements can be aligned in the first direction. Advantageously, the lens means have a convex cylindrical lens surface on a first cylindrical lens element, a concave cylindrical lens surface on a second cylindrical lens element and a spherical lens element which is located between the two cylindrical lens elements and which has at least one convex surface. Here, the first cylindrical lens element located in the beam direction behind the modulator plane can be made as a planar-convex cylindrical lens element, the adjoining spherical lens element being made as a biconvex lens and the second cylindrical lens element which follows in the beam direction being made as a planar-convex cylindrical lens. Greater enlargement in the first direction, than in the second, can be achieved with simple means by this arrangement.

It is possible to use both modulators which can be operated in a transmission arrangement and also modulators which can be operated in a reflection arrangement.

### BRIEF DESCRIPTION OF THE DRAWINGS

Other features and advantages of this invention become clear using the following description of preferred embodiments with reference to the attached drawings:

FIG. 1 shows a schematic side view of a device as claimed in the invention;

FIG. 2 shows a side view of the device as shown in FIG. 1 turned 90 degrees;

FIG. 3 shows a view along arrow III in FIG. 1;

FIG. 4 shows a view along arrow IV in FIG. 1;

FIG. 5 shows a sketch of one embodiment of a carrier device for a thermally sensitive medium; and

FIG. 6 shows a detailed view along arrow VI in FIG. 5.

### DETAILED DESCRIPTION OF THE INVENTION

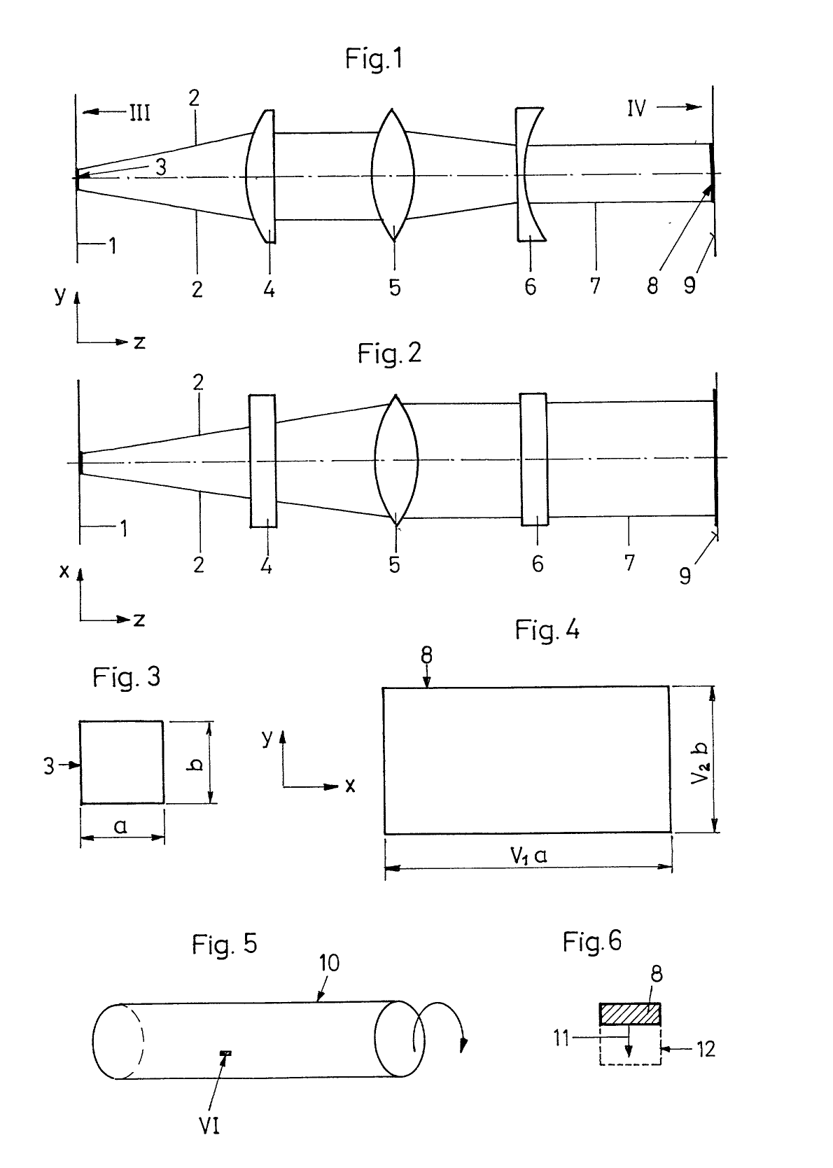

The devices as covered in the invention are shown in FIGS. 1 and 2, and are for imaging of modulated light onto a thermally sensitive medium. These schematics are intended to illustrate essential components of devices as contemplated by the invention. There is one coordinate system for better orientation in each of the figures.

On the left in FIGS. 1 and 2, is the modulator plane 1 from which a beam 2 of modulated light emerges in the z direction. It can be provided that light, for example, of a laser diode bar is suited and, as is generally known from the existing art, is imaged onto an optical modulator. The light beam 2 emerges from the optical modulator or from the plane of modulation. Here, the modulator can be operated in a transmission or in a reflection arrangement. FIG. 3 shows that the light beam 2, shown by way of example in the modulator plane, has a beam cross-section 3 which is square. This means that the dimensions a and b given in FIG. 3 are the same.

As is apparent from looking at FIGS. 1 and 2 together, the divergence of the beam 2 emerging from the modulator plane 1, which is assumed by way of example, is the same in the x direction and the y direction. In the z direction, i.e., in the propagation direction of the light beam 2, downstream of the modulator plane, there are a first cylindrical lens element 4, a spherical lens element 5 and a second cylindrical lens element 6. The first cylindrical lens element 4 is made as a planar-convex cylindrical lens. The spherical lens element 5 is made as a biconvex lens. The second cylindrical lens element 6 is made as a planar-concave cylindrical lens. These embodiments of the individual lens elements or the embodiments of the objective lens unit given by the lens elements 4, 5, 6 can be regarded as examples. Similar lenses can also be used which in combination achieve the effect to be detailed below.

As is apparent from FIG. 1 and 2, the cylinder axes of the first and the second cylindrical lens element 4, 6 are aligned in the x direction. Therefore, the x component (see FIG. 2) of the light beam 2 passing through the cylindrical lens elements 4, 6 does not experience any deflection, but simply a minimum beam offset which is not shown. The x component, as is apparent from FIG. 2, is refracted simply on the spherical lens element 5 such that the beam 2 which is divergent upstream of the inlet into the spherical lens element 5 emerges as a beam 7 which propagates parallel in the z direction from the spherical lens element. Conversely, the y component of the light beam 2, as it passes through the first and the second cylindrical lens elements 4, 6 likewise, experiences refraction so that the light beam 7 after emerging from the second cylindrical lens element 6 is also parallel with respect to its y component, but the extension of the light beam 7 in the y direction being smaller than that in the x direction. This is especially apparent from FIG. 4 which shows the beam cross-section 8 of the light beam 7 in the imaging plane 9. The combination of the two cylindrical lens elements 4, 6 and of the spherical lens element 5, as encompassed in the invention, thus causes a greater enlargement V₁ in the x direction and an enlargement V₂ smaller than the latter in the y direction. This is illustrated by the dimensioning of V₁a and V₂b in FIG. 4. In the imaging plane 9 as covered by the invention, there will be the thermally sensitive medium that, for example, can be attached to a carrier device 10 which is shown schematically, for example, in FIG. 5.

The carrier device 10 represents a roller which can be, for example, the print roller of a laser printer. In the embodiment shown, the carrier device 10, which is made as a roller, can be turned clockwise around its cylinder axis. The detail fo the surface of the carrier device 10, shown in FIG. 6, illustrates that the beam cross-section 8 shown in FIG. 4 in the imaging plane 9 in the form of a rectangular strikes the surface of the carrier device 10 which is formed from the thermally sensitive medium. By turning the carrier device 10, the area of the surface of the carrier device 10, illuminated by the beam 7, is enlarged along the arrow 11 in FIG. 6, until overall during the irradiation process with the light beam 7, a square cutout 12 which is shown in FIG. 6 partially by broken lines, is illuminated.

Instead of forming the carrier device 10 as a roller, other versions are possible. It is also possible to move the surface of the carrier device 10 provided with the thermally sensitive medium by linear displacement and not by rotation. It is essential to the invention that for illumination of a surface cutout 12 of the carrier device 10 which is used as the pixel for a printing process, or the like, a beam 7 with a cross-section 8 deviating from the square shape is chosen, this beam cross-section being moved over the entire pixel surface for the is duration of illuminating, one such square pixel surface for a suitable time interval the next pixel of the graphic to be prepared or the like can be illuminated. Alternatively, by the corresponding beam splitting means, or the like, which are located, for example, upstream of the modulator plane, several pixel surface, or all pixel surfaces, can be illuminated at the same time.

Shrinkage of the beam cross-section which illuminates one pixel surface, as embodied in the invention, in the direction of motion of the surface of the carrier device 10 for the thermally sensitive medium, increases the transmitted power per surface so that especially for thermally comparatively less sensitive media even with low beam intensity the threshold value necessary for the initiation of a writing process, or the like, can be exceeded.

What is claimed is:

1. A device for imaging of modulated light onto a thermally sensitive medium, comprising: a lens means which images a beam cross-section of a light beam which emerges from a modulator plane onto a surface of a thermally sensitive medium, wherein the lens means are made such that the beam cross-section which emerges from the modulator plane can be imaged in a first direction (x) more dramatically enlarged, or more weakly reduced, onto the surface of the thermally sensitive medium than in a second direction (y), and at least for a duration of irradiation of the surface of the thermally sensitive medium with an imaged light beam imaged by the lens means, the surface can be moved in the second direction (y).

2. The device as claimed in claim 1, wherein the first direction (x) and the second direction (y) are essentially perpendicular to one another and to a propagation direction (z) of the light beam.

3. The device as claimed in claim 1, wherein the beam cross-section of the light beam emerging from the modulator plane is essentially square and wherein a cross-section of the imaged light beam striking the surface of the thermally sensitive medium is rectangular due to a different enlargement in the first direction (x) and the second direction (y), and a speed of motion of the surface in the second direction (y) can be chosen such that a surface cutout irradiated during an interval of irradiation by the imaged light beam with a rectangular cross-section is square.

4. The device as claimed in claim 1, wherein movement of the surface of the thermally sensitive medium in the second direction (y) is achieved by the surface being located on a roller-shaped carrier device, and the surface can be moved in the second direction (y) by turning a carrier device around its roller axis.

5. The device as claimed in claim 1, wherein movement of the surface of the thermally sensitive medium in the second direction (y) can be achieved by linear motion of a carrier device which bears the surface.

6. The device as claimed in claim 1, wherein the lens means comprises cylindrical lens element.

7. The device as claimed in claim 6, wherein a cylinder axes of the cylindrical lens elements are aligned in the first direction (x).

8. The device as claimed in claim 6, wherein the lens means comprises a convex cylindrical lens surface on a first cylindrical lens element, a concave cylindrical lens surface on a second cylindrical lens element and a spherical lens element having at least one convex surface, which is located between the first cylindrical lens element and the second cylindrical lens element.

9. The device as claimed in claim 8, wherein the first cylindrical lens element located in a beam direction behind the modulator plane is made as a planar-convex cylindrical lens element, wherein the spherical lens element is made as a biconvex lens and wherein the second cylindrical lens element which follows in the beam direction (z) is made as a planar-convex cylinder.

10. The device as claimed in claim 1, wherein the modulator can be operated in a transmission or in a reflection arrangement.
